(19) United States
(12) Patent Application Publication
(10) Pub. No.: US 2020/0213458 A1
(43) Pub. Date: Jul. 2, 2020

(54) IMAGE PROCESSING APPARATUS

(71) Applicant: SHARP KABUSHIKI KAISHA, Sakai City (JP)

(72) Inventors: TAKASHI HARA, Sakai City (JP); TOHRU NISHIKAWA, Osaka-shi (JP)

(21) Appl. No.: 16/724,107

(22) Filed: Dec. 20, 2019

(30) Foreign Application Priority Data
Dec. 26, 2018 (JP) 2018-242857

(51) Int. Cl. H04N 1/00

(52) U.S. Cl. CPC H04N 1/00469; H04N 1/00474; H04N 1/0044

(57) ABSTRACT

Provided is an image processing apparatus including a controller that performs control to display a preview image and display information other than the preview image on a display. The display includes a preview image display area in which a preview image is displayed, and when one or more preview images displayed in the preview image display area are enlarged or reduced, the controller performs control to enlarge or reduce the display information displayed on the display.

This Nonprovisional application claims priority under 35 U.S.C. § 119(a) on Patent Application No. 2018-242857 filed in Japan on 26 Dec. 2018, the entire contents of which are hereby incorporated by reference.

### BACKGROUND OF THE INVENTION

### Field of the Invention

The present invention relates to an image processing apparatus, and particularly, to an image processing apparatus for displaying a preview image and display information other than the preview image on a display screen.

### Description of the Background Art

In recent years, there has been known an image processing apparatus for generating a preview image based on input image data to display a preview on a display screen in an operation processor.

Among conventional image processing apparatuses, there has been disclosed an image processing apparatus in which, for example, a part of a plurality of preview images displayed in a preview image display area is enlarged and displayed as an enlarged preview image (see Japanese Unexamined Patent Application Publication No. 2008-245034, hereinafter, Patent Document 1).

However, the technology in Patent Document 1 has a problem in that even if the preview image displayed on the display screen is displayed as the enlarged preview image, the size of the other display information remains unchanged, and thus, the presence of the display information is decreased, resulting in an interface having relatively poor visibility of the display information.

If, for example, contrary to the above, the preview image is reduced and displayed to improve the visibility of the display information, the size of the display information remains unchanged, and thus, the presence of the preview image is relatively decreased, resulting in another problem in that it is greater difficult to view the preview image.

The present invention has been made in view of the above-described conventional problems, and an object thereof is to provide an image processing apparatus capable of realizing an interface with good visibility by making it easier to see a preview image and other display information when the preview image is displayed.

### SUMMARY OF THE INVENTION

The present invention is an image processing apparatus including a controller that performs control to display a preview image and display information other than the preview image on a display screen The display screen includes a preview image display area in which a preview image is displayed, and when one or more preview images displayed in the preview image display area are enlarged or reduced, the controller performs control to enlarge or reduce the display information displayed on the display screen.

According to the image processing apparatus of the present invention, it is possible to provide an image processing apparatus including a controller that performs control to display a preview image and display information other than the preview image on a display screen. The display screen includes a preview image display area in which a preview image is displayed, and when one or more preview images displayed in the preview image display area are enlarged or reduced, the controller performs control to enlarge or reduce the display information displayed on the display screen, thus realizing an interface with good visibility by making it easier to see the preview image and the other display information.

### BRIEF DESCRIPTION OF THE DRAWINGS

FIG. 1 is a block diagram illustrating a configuration of an image forming apparatus according to a first embodiment;

FIG. 2 is a schematic explanatory diagram illustrating the configuration of the image forming apparatus;

FIG. 3A is an explanatory diagram illustrating a state in which a preview image is displayed on a display of the image forming apparatus, and FIG. 3B is an explanatory diagram illustrating a display state of the other display information when the preview image is enlarged and displayed;

FIG. 4A is an explanatory diagram illustrating a state in which a preview image is displayed on a display of an image forming apparatus according to a second embodiment, and FIG. 4B is an explanatory diagram illustrating a display state of the other display information when the preview image is enlarged and displayed;

FIG. 5A is an explanatory diagram illustrating a state in which a preview image is displayed on a display of an image forming apparatus according to a third embodiment, FIG. 5B is an explanatory diagram illustrating a display state of a Copy button when the preview image is enlarged and displayed, and FIG. 5C is an explanatory diagram illustrating a display state of character information when the preview image is enlarged and displayed;

FIG. 6A is an explanatory diagram illustrating a state in which a preview image is displayed on a display of an image forming apparatus according to a fourth embodiment, and FIG. 6B is an explanatory diagram illustrating a display state of display information when the preview image is enlarged and displayed;

FIG. 7A is an explanatory diagram illustrating a state in which a preview image is displayed on a display of an image forming apparatus according to a fifth embodiment, and FIG. 7B is an explanatory diagram illustrating a display state of character information and a Copy button when the preview image is enlarged and displayed;

FIG. 8A is an explanatory diagram illustrating a state in which a preview image is displayed on a display of an image forming apparatus according to a sixth embodiment, and FIG. 8B is an explanatory diagram illustrating a display state of character information and a Copy button when the preview image is enlarged and displayed;

FIG. 9A is an explanatory diagram illustrating a state in which a preview image is displayed on a display of an image forming apparatus according to a seventh embodiment, and FIG. 9B is an explanatory diagram illustrating a display state of character information and a Copy button when the preview image is enlarged and displayed;

FIG. 10A is an explanatory diagram illustrating a state in which a preview image is displayed on a display of an image forming apparatus according to an eighth embodiment, and FIG. 10B is an explanatory diagram illustrating a display state of a preview image display area and a display state of character information and a Copy button when the preview image is enlarged and displayed;

FIG. 11A is an explanatory diagram illustrating a state in which one page of a preview image is displayed on a display of an image forming apparatus according to a ninth embodiment, and FIG. 11B is an explanatory diagram illustrating a state in which two pages of preview images are displayed on the display; and

FIG. 12A is an explanatory diagram illustrating a state in which a preview image is displayed longitudinally on a display of an image forming apparatus according to a tenth embodiment, and FIG. 12B is an explanatory diagram illustrating a state in which the preview image is displayed laterally on the display.

### DESCRIPTION OF THE PREFERRED EMBODIMENTS

### First Embodiment

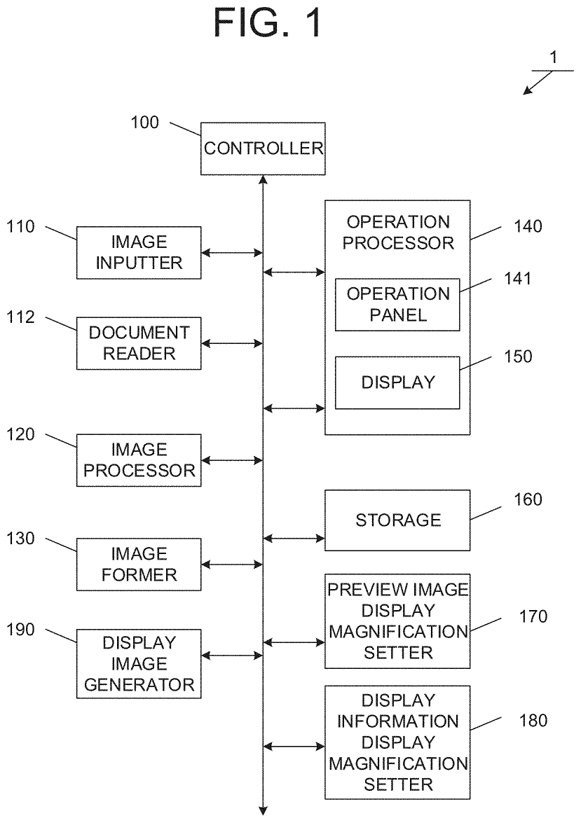

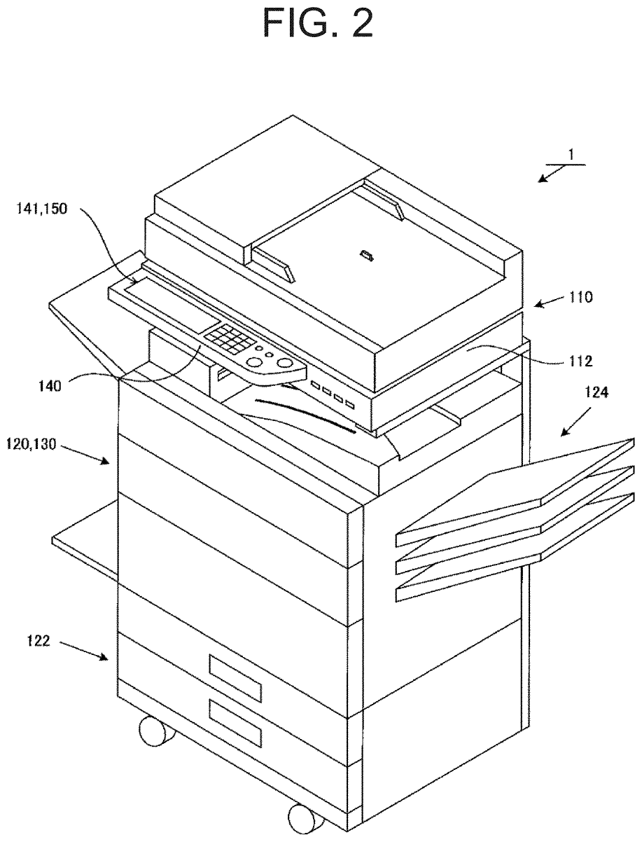

A first embodiment according to the present invention will be described below with reference to the accompanying drawings. FIG. 1 is a block diagram illustrating a configuration of an image forming apparatus according to the first embodiment of the present invention, which is an example of embodiments of the present invention, and FIG. 2 is a schematic explanatory diagram illustrating a configuration of the image forming apparatus.

As illustrated in FIG. 1, the first embodiment is an image forming apparatus 1 being an image processing apparatus including the controller 100 that performs control to display a preview image and display information other than the preview image on a display 150. When the preview image displayed on the display 150 is enlarged or reduced, the controller 100 performs control to enlarge or reduce the display information displayed on the display 150.

Configuration of Image Forming Apparatus

First, a basic configuration of the image forming apparatus 1 according to the first embodiment will be described. As illustrated in FIG. 2, the image forming apparatus 1 is an image processing apparatus for electrophotographically outputting an image and includes, in the upper part of the apparatus main body, a document reader 112 that reads an image in a document. Moreover, as illustrated in FIG. 1, the image forming apparatus 1 mainly includes a controller 100, an image inputter 110, the document reader 112, an image processor 120, an image former 130, an operation processor 140, a display 150, and a storage 160, and further includes a preview image display magnification setter 170, a display information display magnification setter 180, and a display image generator 190.

The controller 100 is a functional unit that controls the entire image forming apparatus 1. Moreover, the controller 100 realizes various functions by reading and executing various programs, and includes, for example, one or more arithmetic devices (for example, a central processing unit (CPU)).

Further, according to the first embodiment, when the preview image is enlarged or reduced and displayed, the controller 100 performs control to set the display magnification of the preview image by the preview image display magnification setter 170, and based on the resulting magnification, set the display magnification of the other display information by the display information display magnification setter 180, and then based on the resulting magnification, generate a display image having the preview image and the other display information by the display image generator 190.

The image inputter 110 is a functional unit that reads image data input to the image forming apparatus 1. Moreover, the image inputter 110 is coupled to the document reader 112 being a functional unit that reads an image in a document, and receives image data output from the document reader 112.

Further, the image inputter 110 may receive image data from a storage medium such as a universal serial bus (USB) memory or a secure digital (SD) card. The image inputter 110 may include a communicator that connects the image inputter 110 with another terminal device and receive image data from the other terminal device.

The image processor 120 is a functional unit that performs various image processes on image data. In addition, the image processor 120 forms an output image, based on the image data on which an image process is performed.

The image former 130 is a functional unit that forms, on a recording medium (for example, a recording sheet), output data based on the image data. For example, as illustrated in FIG. 2, a recording sheet is fed from a sheet feed tray 122, an image is formed on a surface of the recording sheet in the image former 130, and then the sheet is ejected from a sheet discharge tray 124. The image former 130 includes, for example, a laser printer or the like utilizing an electrophotographic method.

The operation processor 140 is a functional unit that receives operational instructions from a user, and includes various key switches, a device that detects a touch input, and the like. The user can use the operation processor 140 to input a function to be used and an output condition. The display 150 is a functional unit that displays various types of information to the user, and includes, for example, a liquid crystal display (LCD).

It is noted that the image forming apparatus 1 may include a touch panel in which an operation panel 141 and the display 150 are integrally formed, as illustrated in FIG. 2. In this case, a method for detecting an input on the touch panel may be a common detection method such as a resistive method, touch screen technology utilizing infrared or electromagnetic induction, or a capacitive method.

The storage 160 is a functional unit that stores various programs and various data necessary for an operation of the image forming apparatus 1. The storage 160 includes, for example, a solid state drive (SSD) being a semiconductor memory, and a hard disk drive (HDD).

The preview image display magnification setter 170 sets the magnification at which the preview image is to be enlarged or reduced and displayed. The magnification input instruction may be provided, for example, by a gesture operation from a user such as a pinch-in or pinch-out touch operation on a preview image displayed on the display 150, or an enlarge or reduce switch operation by a slide bar or a button.

The display information display magnification setter 180 sets the magnification at which the display information is to be displayed, based on the magnification of the preview image set by the preview image display magnification setter 170.

The display image generator 190 generates a display image of the display information, based on the magnification set by the display information display magnification setter 180 while generating a preview image, based on the magnification set by the preview image display magnification setter 170.

### Displaying Preview Image by Image Forming Apparatus

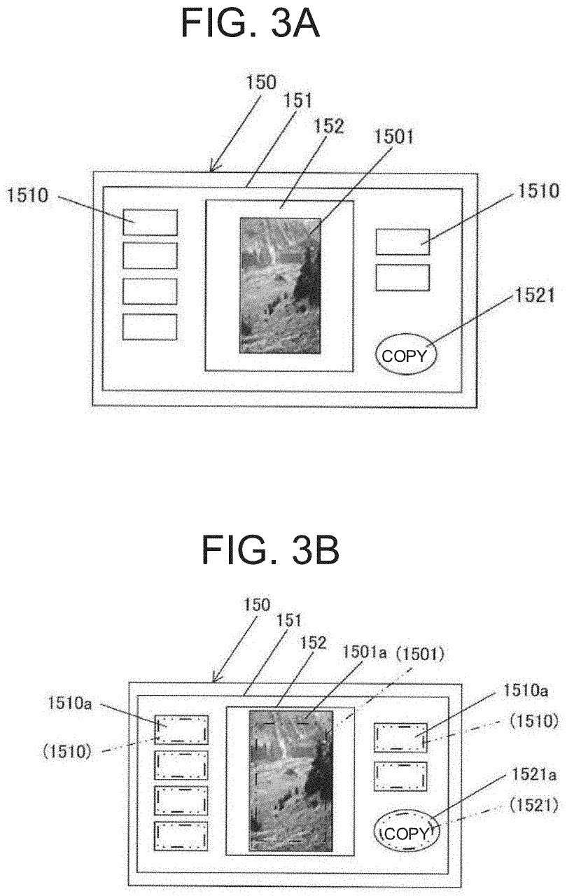

Next, a case in which a preview image is displayed in the image forming apparatus 1 according to the first embodiment will be described. FIG. 3A is an explanatory diagram illustrating a state in which a preview image is displayed on a display of an image forming apparatus according to the first embodiment, and FIG. 3B is an explanatory diagram illustrating a display state of the other display information when the preview image is enlarged and displayed.

As illustrated in FIG. 3A, a display screen 151 is displayed on the display 150 of the image forming apparatus 1. A preview image display area 152 in which a preview image 1501 is displayed is provided on the display screen 151.

In addition, a plurality of items of character information 1510 and a Copy button 1521 are displayed on the display screen 151 as display information other than the preview image. Here, as illustrated in FIG. 3A, the character information 1510 is simplistically displayed as a plurality of rectangular areas. The Copy button (operation button) 1521 is a start button for executing copying.

The preview image 1501 is displayed in the preview image display area 152. When the preview image 1501 is to be enlarged and displayed, for example, a pinch-out operation is performed on the preview image 1501. The magnification at which the preview image 1501 is to be enlarged is set in the preview image display magnification setter 170, based on the pinch-out operation.

In the first embodiment, the enlargement magnification of the character information 1510 and the Copy button 1521 is set by the display information display magnification setter 170, based on the enlargement magnification of the preview image 1501.

Further, as illustrated in FIG. 3B, based on the set enlargement magnification, the preview image 1501, the character information 1510, and the Copy button 1521 are displayed as an enlarged preview image 1501a, an enlarged character information 1510a, and an enlarged Copy button 1521a. A portion indicated by a two-dot chain line in the figure indicates the size of the preview image 1501, the character information 1510, and the Copy button 1521 before being enlarged.

In the display information display magnification setter 170, based on the display position and the display interval of the character information 1510 and the Copy button 1521 before the execution of the enlargement or reduction processing, the positions of the display information are appropriately adjusted in correspondence to the magnification so that the display information does not overlap and also does not move away too much from each other when the enlargement or reduction processing is performed.

As a result of the above configuration, according to the first embodiment, it is possible to provide the image forming apparatus 1 capable of realizing an interface with good visibility by displaying the preview image 1501, the character information 1510, and the Copy button 1521 in an easy to view manner as the controller 100 enlarges and displays the character information 1510 and the Copy button 1521 same as the preview image 1501, when the preview image 1501 is enlarged and displayed, in the image forming apparatus 1.

### Second Embodiment

Next, a second embodiment will be described. According to the second embodiment, in the image forming apparatus 1, when two preview images displayed on the display 150 are enlarged or reduced, the controller 100 performs control to enlarge the display information displayed on the display 150.

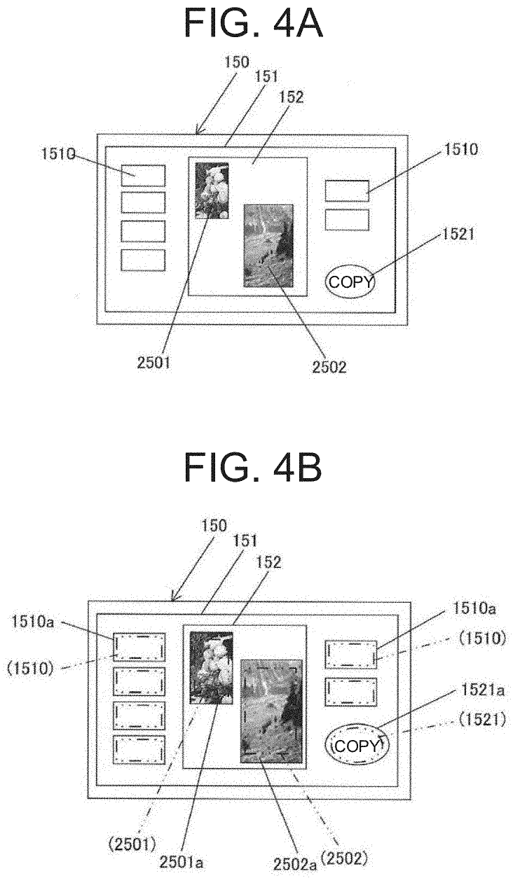

FIG. 4A is an explanatory diagram illustrating a state in which a preview image is displayed on a display of an image forming apparatus according to the second embodiment, and FIG. 4B is an explanatory diagram illustrating a display state of the other display information when the preview image is enlarged and displayed.

It is noted that in the second embodiment, for convenience of explanation, components having the same functions as those in the first embodiment are designated by using the same reference numerals, and description for those components will be omitted.

In the second embodiment, as illustrated in FIG. 4A, two preview images 2501 and 2502 are displayed in the preview image display area 152 of the display screen 151 of the display 150 of the image forming apparatus 1.

In the second embodiment, the two different preview images 2501 and 2502 are displayed at the same enlargement magnification. Moreover, the enlargement magnification of the character information 1510 and the Copy button 1521 is set by the display information display magnification setter 170, based on the enlargement magnification of the two preview images 2501 and 2502.

Further, as illustrated in FIG. 4B, based on the set enlargement magnification, the two preview images 2501 and 2502, the character information 1510, and the Copy button 1521 are displayed as the two enlarged preview images 2501a and 2502a, the enlarged character information 1510a, and the enlarged Copy button 1521a.

As a result of the above configuration, according to the second embodiment, it is possible to display even the other character information 1510 and the Copy button 1521 in an easy to view manner as the controller 100 enlarges and displays the character information 1510 and the Copy button 1521 same as the two preview images 2501 and 2502, when the two preview images 2501 and 2502 are enlarged and displayed, in the image forming apparatus 1.

### Third Embodiment

Next, a third embodiment will be described. According to the third embodiment, in the image forming apparatus 1, when the preview image displayed on the display 150 is enlarged or reduced, the controller 100 performs control to enlarge only the operation button from the display information displayed on the display 150.

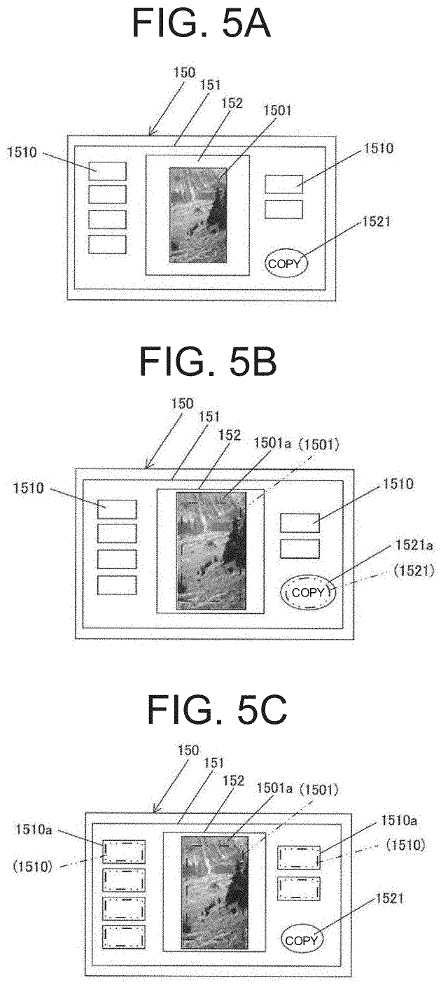

FIG. 5A is an explanatory diagram illustrating a state in which a preview image is displayed on a display of an image forming apparatus according to a third embodiment, FIG. 5B is an explanatory diagram illustrating a display state of a Copy button when the preview image is enlarged and displayed, and FIG. 5C is an explanatory diagram illustrating a display state of character information when the preview image is enlarged and displayed.

It is noted that in the third embodiment, for convenience of explanation, components having the same functions as those in the first embodiment are designated by using the same reference numerals, and description for those components will be omitted.

In the third embodiment, as illustrated in FIG. 5A, the preview image 1501 is displayed in the preview image display area 152 of the display screen 151 of the display 150 of the image forming apparatus 1. In addition, the plurality of items of character information 1510 and the Copy button 1521 are displayed on the display screen 151.

In the third embodiment, the enlargement magnification of the Copy button 1521 is set by the display information display magnification setter 170, based on the enlargement magnification of the preview image 1501. The character information 1510 is not enlarged.

As illustrated in FIG. 5B, when the preview image 1501 is enlarged and displayed, the preview image 1501 and the Copy button 1521 are displayed as the enlarged preview image 1501a and the enlarged Copy button 1521a.

As a result of the above configuration, according to the third embodiment, it is possible to display the Copy button 1521 in an easy to view manner, and also realize an interface with good visibility the controller 100 enlarges only the Copy button 1521 same as the preview image 1501, when the preview image 1501 is enlarged and displayed, in the image forming apparatus 1.

It is noted that as illustrated in FIG. 5C, instead of the Copy button 1521, the character information 1510 may be displayed same as the preview image 1501 as the enlarged preview image 1501a and the enlarged character information 1510a, based on the set enlargement magnification.

### Fourth Embodiment

Next, a fourth embodiment will be described. According to the fourth embodiment, in the image forming apparatus 1, when the preview image displayed on the display 150 is enlarged or reduced, the controller 100 performs control to display and enlarge the display information in the preview image display area 152.

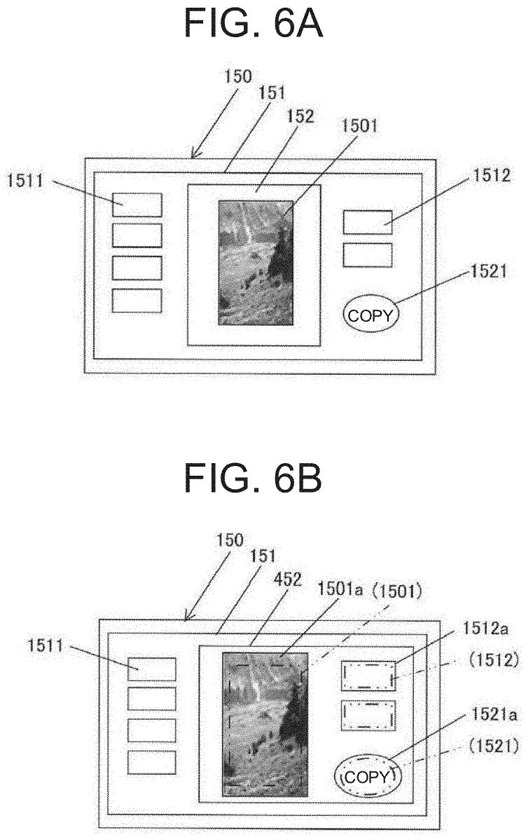

FIG. 6A is an explanatory diagram illustrating a state in which a preview image is displayed on a display of an image forming apparatus according to a fourth embodiment, and FIG. 6B is an explanatory diagram illustrating a display state of display information when the preview image is enlarged and displayed.

It is noted that in the fourth embodiment, for convenience of explanation, components having the same functions as those in the first embodiment are designated by using the same reference numerals, and description for those components will be omitted.

In the fourth embodiment, as illustrated in FIG. 6A, the preview image 1501 is displayed in the preview image display area 152 of the display screen 151 of the display 150 of the image forming apparatus 1. In addition, the plurality of items of character information 1511, and character information 1512 and Copy button 1521 related to a plurality of preview images are displayed on the display screen 151. Examples of the character information related to the preview image include magnification, image editing, and mage forming condition change.

In the fourth embodiment, as illustrated in FIG. 6B, when the preview image 1501 is enlarged and displayed, the character information 1512 and the Copy button 1521 related to the preview image 1501 are displayed as the enlarged character information 1512a and the enlarged Copy button 1521a together with the enlarged preview image 1501a, in the enlarged preview image display area 452.

The character information 1512 and the Copy button 1521 are displayed based on the enlargement magnification of the preview image 1501.

As a result of the above configuration, according to the fourth embodiment, it is possible to display the character information 1512 and the Copy button 1521 in an easy to view manner, and also realize an interface with good visibility, as the controller 100 enlarges and displays the character information 1512 and the Copy button 1521 related to the preview image 1501 together with the preview image 1501 in the preview image display area 452, when the preview image 1501 is enlarged and displayed, in the image forming apparatus 1.

### Fifth Embodiment

Next, a fifth embodiment will be described. According to the fifth embodiment, in the image forming apparatus 1, when the preview image displayed on the display 150 is enlarged or reduced, the controller 100 sets the magnification at which the preview image is to be enlarged or reduced and displayed to be different from the magnification at which the display information is to be enlarged or reduced and displayed.

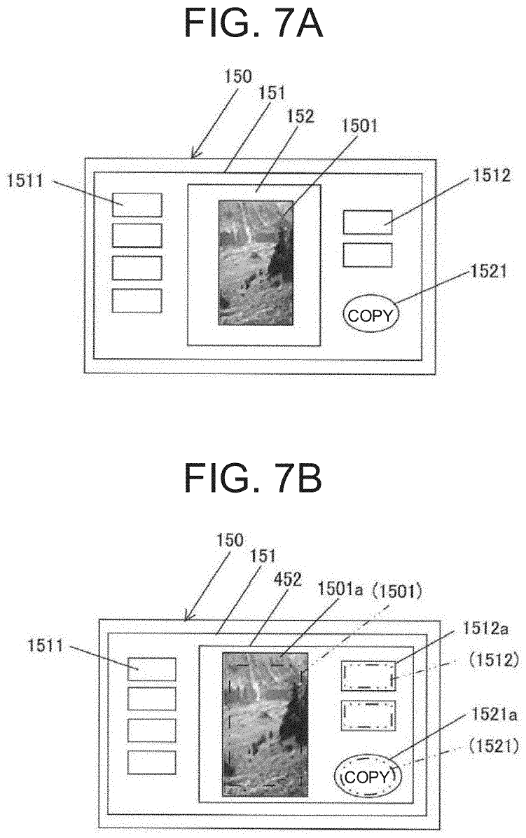

FIG. 7A is an explanatory diagram illustrating a state in which a preview image is displayed on a display of an image forming apparatus according to a fifth embodiment, and FIG. 7B is an explanatory diagram illustrating a display state of character information and a Copy button when the preview image is enlarged and displayed.

It is noted that in the fifth embodiment, for convenience of explanation, components having the same functions as those in the first embodiment are designated by using the same reference numerals, and description for those components will be omitted.

In the fifth embodiment, as illustrated in FIG. 7A, the preview image 1501 is displayed in the preview image display area 152 of the display screen 151 of the display 150 of the image forming apparatus 1. In addition, the plurality of items of character information 1510 and the Copy button 1521 are displayed on the display screen 151.

In the fifth embodiment, the enlargement magnification of the character information 1510 is set by the display information display magnification setter 170, based on the enlargement magnification of the preview image 1501. At this time, the enlargement magnification of the preview image 1501 is set to be different from the enlargement magnification of the character information 1510. Here, the enlargement magnification of the character information 1510 is set to be larger than that of the preview image 1501 such that the character information 1510 can be easily seen. The Copy button 1521 is not enlarged.

As illustrated in FIG. 7B, when the preview image 1501 is enlarged and displayed, the character information 1510 is displayed as enlarged character information 1510b.

As a result of the above configuration, according to the fifth embodiment, it is possible to display the character information 1510 in an easy to view manner as the controller 100 sets the enlargement magnification of the preview image 1501 to be different from the enlargement magnification of the character information 1510, for example, sets the enlargement magnification of the character information 1510 to be larger than that of the preview image 1501, when the preview image 1501 is enlarged and displayed, in the image forming apparatus 1. This enables an interface with good visibility.

It is noted that instead of the character information 1510, the Copy button 1521 at an enlargement magnification different from that of the preview image 1501 may be displayed.

### Sixth Embodiment

Next, a sixth embodiment will be described. According to the sixth embodiment, in the image forming apparatus 1, when the preview image displayed on the display 150 is enlarged or reduced, the controller 100 displays an operation button for executing a function related to image editing as the display information to be displayed.

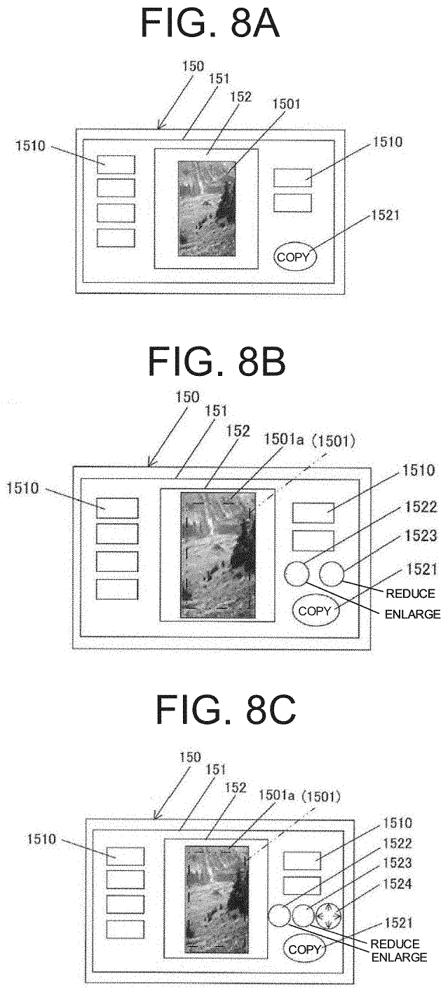

FIG. 8A is an explanatory diagram illustrating a state in which a preview image is displayed on a display of an image forming apparatus according to the sixth embodiment, and FIG. 8B is an explanatory diagram illustrating a display state of character information and a Copy button when the preview image is enlarged and displayed.

It is noted that in the sixth embodiment, for convenience of explanation, components having the same functions as those in the first embodiment are designated by using the same reference numerals, and description for those components will be omitted.

In the sixth embodiment, as illustrated in FIG. 8A, the preview image 1501 is displayed in the preview image display area 152 of the display screen 151 of the display 150 of the image forming apparatus 1. In addition, the plurality of items of character information 1510 and the Copy button 1521 are displayed on the display screen 151.

In the sixth embodiment, as illustrated in FIG. 8B, when the preview image 1501 is enlarged and displayed, an Enlarge button 1522 and a Reduce button 1523 are displayed as the display information to be displayed. Here, the character information 1510 and the Copy button 1521 are not enlarged.

It can be clarified that the Enlarge button 1522 and the Reduce button 1523 are additionally displayed on the display screen 151 by not enlarging the character information 1510 and the Copy button 1521 when the preview image 1501 is enlarged and displayed.

As a result of the above configuration, according to the sixth embodiment, it is possible to realize an interface with excellent operability, such as image editing as the controller 100 additionally displays the Enlarge button 1522 and the Reduce button 1523 related to the enlargement or reduction display of the preview image 1501 as the display information, when the preview image 1501 is enlarged and displayed, in the image forming apparatus 1.

It is noted that as a modification, as illustrated in FIG. 8C, apart from the additional display of the Enlarge button 1522 and the Reduce button 1523, a Move button (scroll button) 1524 capable of moving the preview image 1501a longitudinally or laterally may also be displayed when the preview image 1501 is enlarged and displayed.

Further, for example, a Display Reset button, an Image Editing button, or the like may be displayed as operation buttons used for executing functions related to image editing that are to be additionally displayed on the display screen 151.

### Seventh Embodiment

Next, a seventh embodiment will be described. According to the seventh embodiment, in the image forming apparatus 1, when the preview image displayed on the display 150 is enlarged or reduced, the controller 100 specifies the upper limit of the magnification at which the display information is to be enlarged or reduced and displayed regardless of the magnification at which the preview image is enlarged or reduced and displayed.

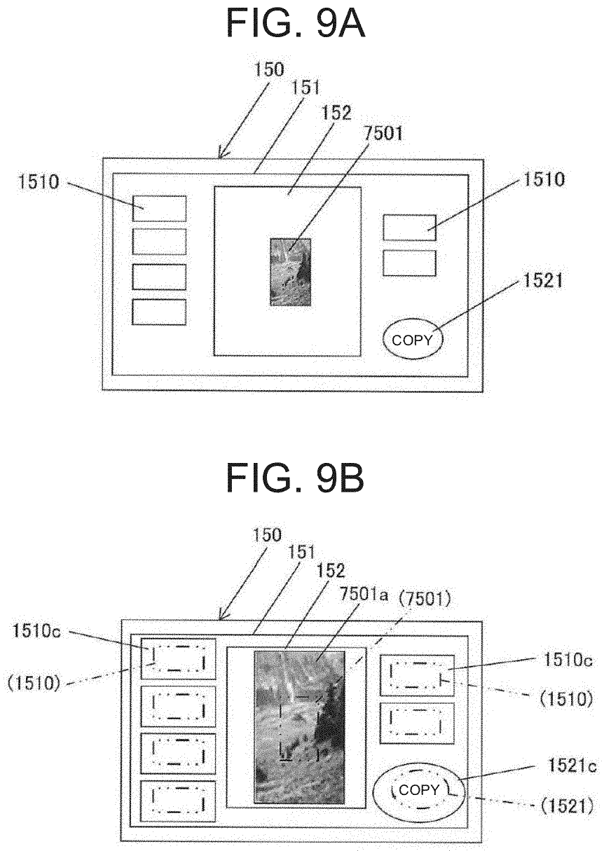

FIG. 9A is an explanatory diagram illustrating a state in which a preview image is displayed on a display of an image forming apparatus according to the seventh embodiment, and FIG. 9B is an explanatory diagram illustrating a display state of character information and a Copy button when the preview image is enlarged and displayed.

It is noted that in the seventh embodiment, for convenience of explanation, components having the same functions as those in the first embodiment are designated by using the same reference numerals, and description for those components will be omitted.

In the seventh embodiment, as illustrated in FIG. 9A, a preview image 7501 is displayed in the preview image display area 152 of the display screen 151 of the display 150 of the image forming apparatus 1. In addition, the plurality of items of character information 1510 and the Copy button 1521 are displayed on the display screen 151.

In the seventh embodiment, as illustrated in FIG. 9B, when the preview image 7501 is greatly enlarged and displayed, the upper limit of the enlargement magnification of the character information 1510 and the Copy button 1521 is set regardless of the enlargement magnification of the preview image 7501, and the enlarged character information 1510c and the enlarged Copy button 1521c are displayed on the display screen 151 without being superimposed.

Here, the enlargement magnification of the preview image 7501 is set to around four times. The enlargement magnification of the character information 1510 and the Copy button 1521 is set to around two times, and is set to be smaller than the enlargement magnification of the preview image 7501.

As a result, when the small preview image 7501 is enlarged and displayed at a large magnification, the character information 1510 and the Copy button 1521 are enlarged and displayed at an easily viewable magnification without being too large.

As a result of the above configuration, according to the seventh embodiment, it is possible to realize an interface with excellent visibility and operability since the controller 100 sets the upper limit of the magnification at which the character information 1510 and the Copy button 1521 are to be enlarged and displayed regardless of the magnification at which the preview image 7501 is enlarged and displayed such that the character information 1510 and the Copy button 1521 can be displayed at an easily viewable magnification without being superimposed, when the preview image 7501 is enlarged and displayed, in the image forming apparatus 1.

### Eighth Embodiment

Next, an eighth embodiment will be described. According to the eighth embodiment, in the image forming apparatus 1, the controller 100 performs control to enlarge or reduce and display the preview image display area while enlarging or reducing and displaying the preview image.

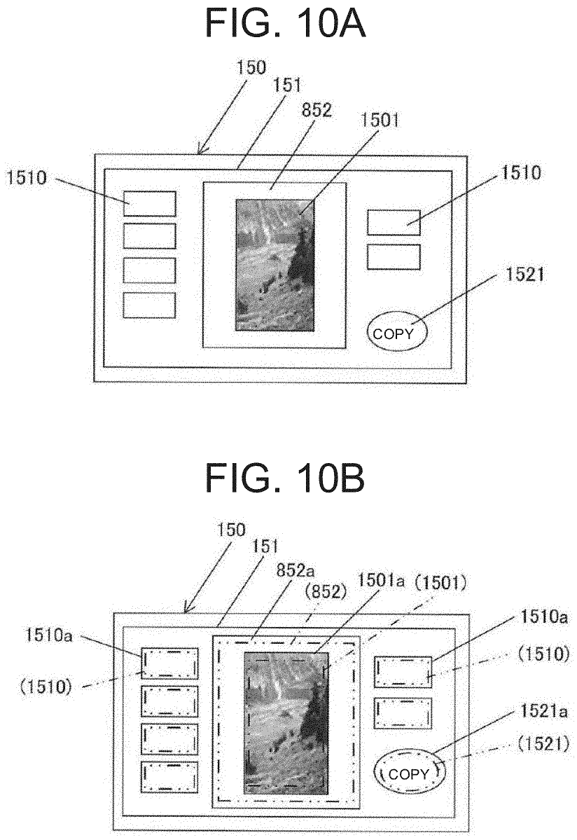

FIG. 10A is an explanatory diagram illustrating a state in which a preview image is displayed on a display of an image forming apparatus according to the eighth embodiment, and FIG. 10B is an explanatory diagram illustrating a display state of a preview image display area and a display state of character information and a Copy button when the preview image is enlarged and displayed.

It is noted that in the eighth embodiment, for convenience of explanation, components having the same functions as those in the first embodiment are designated by using the same reference numerals, and description for those components will be omitted.

In the eighth embodiment, as illustrated in FIG. 10A, the preview image 1501 is displayed in a preview image display area 852 of the display screen 151 of the display 150 of the image forming apparatus 1. In addition, the plurality of items of character information 1510 and the Copy button 1521 are displayed on the display screen 151.

In the eighth embodiment, as illustrated in FIG. 10B, when the preview image 1501 is enlarged and displayed, the preview image display area 852 is controlled to be enlarged and displayed.

Here, the preview image display area 852a is enlarged and displayed at the same enlargement magnification as the enlargement magnification of the preview image 1501. Similarly, the character information 1510a and the Copy button 1521a are also enlarged and displayed at the same enlargement magnification as the enlargement magnification of the preview image 1501.

Thus, the preview image 1501 can be enlarged and displayed without difficulty in the preview image display area 852.

As a result of the above configuration, according to the eighth embodiment, it is possible to realize an interface with excellent visibility since the controller 100 performs control to enlarge and display the preview image display area 852 such that the preview image 1501 can be displayed in an easily viewable state in the preview image display area 852, when the preview image 1501 is enlarged and displayed, in the image forming apparatus 1.

### Ninth Embodiment

Next, a ninth embodiment will be described. According to the ninth embodiment, in the image forming apparatus 1, the controller 100 changes the enlargement or reduction magnification of the preview image in accordance with a number of preview images to be displayed.

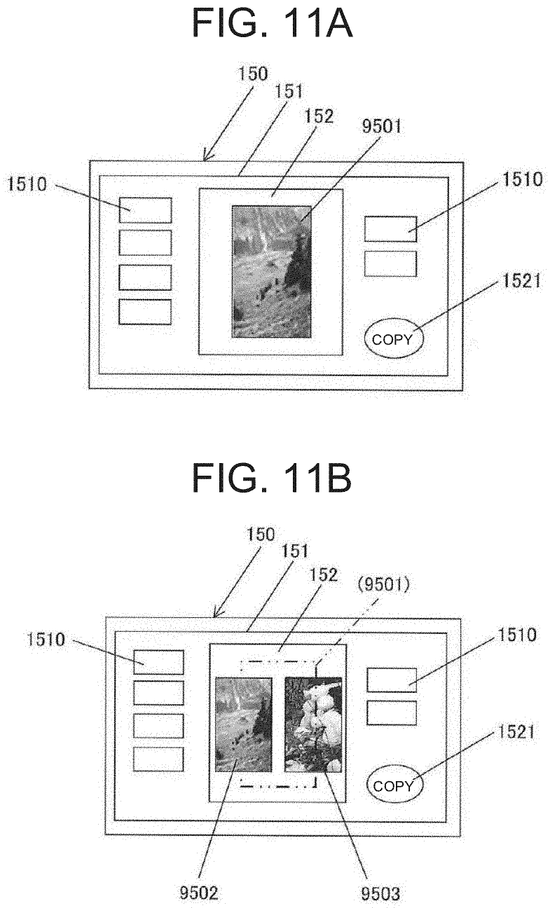

FIG. 11A is an explanatory diagram illustrating a state in which one page of a preview image is displayed on a display of an image forming apparatus according to the ninth embodiment, and FIG. 11B is an explanatory diagram illustrating a state in which two pages of preview images are displayed on the display.

It is noted that in the ninth embodiment, for convenience of explanation, components having the same functions as those in the first embodiment are designated by using the same reference numerals, and description for those components will be omitted.

In the ninth embodiment, as illustrated in FIG. 11A, one page of a preview image 9501 is displayed in the preview image display area 152 of the display screen 151 of the display 150 of the image forming apparatus 1. In addition, the plurality of items of character information 1510 and the Copy button 1521 are displayed on the display screen 151.

In the ninth embodiment, when two pages of preview images 9502 and 9503 are displayed in the preview image display area 152, the preview images 9502 and 9503 are reduced in size and displayed as compared to the display size of one page of the preview image 9501 so that the images are displayed in entirety in the preview image display area 152, as illustrated in FIG. 10B.

When the preview images 9502 and 9503 are displayed in the preview image display area 152 on one page each, the images are displayed with the same display size as the preview image 9501 illustrated in FIG. 11A.

As a result of the above configuration, according to the ninth embodiment, it is possible to realize an interface with excellent operability and visibility since the controller 100 changes the enlargement or reduction magnification of the preview images 9502 and 9503 in accordance with a number of preview images to be displayed to display the preview images 9502 and 9503 such that the preview images 9502 and 9503 are displayed and viewed in entirety in the preview image display area 152 without the need to set the enlargement or reduction magnification for each preview image, when two preview images 9502 and 9503 are displayed in the preview image display area 152, in the image forming apparatus 1.

### Tenth Embodiment

Next, a tenth embodiment will be described. According to the tenth embodiment, in the image forming apparatus 1, the controller 100 enlarges or reduces the preview image display area so that the entire preview image can be displayed in accordance with the preview image being displayed longitudinally or laterally.

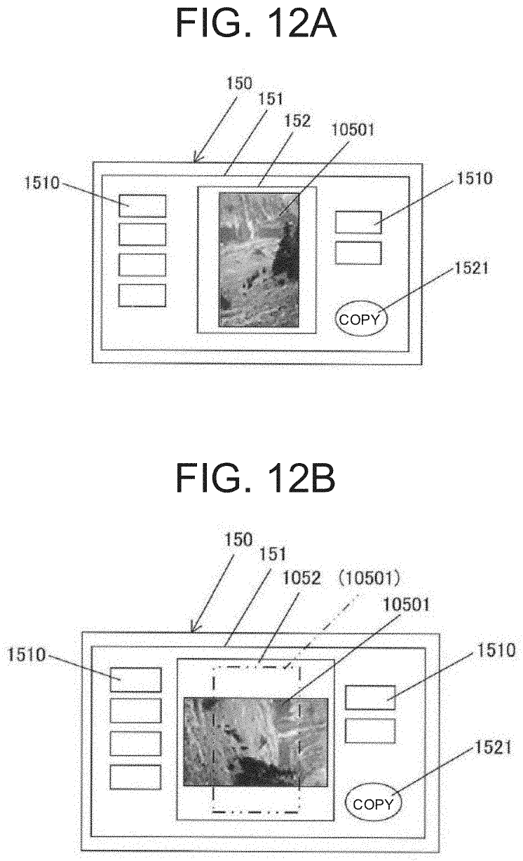

FIG. 12A is an explanatory diagram illustrating a state in which a preview image is displayed longitudinally on a display of an image forming apparatus according to the tenth embodiment, and FIG. 12B is an explanatory diagram illustrating a state in which a preview image is displayed laterally on the display.

It is noted that in the tenth embodiment, for convenience of explanation, components having the same functions as those in the first embodiment are designated by using the same reference numerals, and description for those components will be omitted.

In the tenth embodiment, as illustrated in FIG. 12A, a preview image 10501 is displayed longitudinally in the preview image display area 152 of the display screen 151 of the display 150 of the image forming apparatus 1. In addition, the plurality of items of character information 1510 and the Copy button 1521 are displayed on the display screen 151.

In the tenth embodiment, when the preview image 10501 is displayed on the display screen 151 after the display state of the preview image 10501 is changed from the longitudinally displayed preview image 10501 to the laterally displayed preview image 10501 in the preview image display area 152, a preview image display area 1052 obtained by laterally enlarging the preview image display area 152 is set so that the entire preview image 10501 turned laterally is displayed, as illustrated in FIG. 10B.

Thus, the preview image 10501 is displayed in the state of being turned laterally in the preview image display area 1052.

As a result of the above configuration, according to the tenth embodiment, it is possible to display the entire preview image 10501 even if the preview image 10501 is displayed either longitudinally or laterally, and thus realize an interface with excellent visibility since the preview image display area 1052 obtained by enlarging or reducing the display area is set so that the entire preview image 10501 can be displayed in accordance with the preview image 10501 being displayed longitudinally or laterally, in the image forming apparatus 1.

As described above, the present invention is not limited to the above-described examples and embodiments, and various modifications can be made without departing from the scope of the claims. It is obvious that those skilled in the art can conceive variations or modifications included in the scope of the claims. In other words, the technical scope of the present invention includes embodiments implemented as combinations of technical means modified as appropriate without departing from the spirit of the present invention.

### DESCRIPTION OF REFERENCE NUMERALS

1 Image forming apparatus
100 Controller
140 Operation processor
150 Display
151 Display screen
152, 452, 852, 852a, 1052 Preview image display area
170 Preview image display magnification setter
180 Display information display magnification setter
190 Display image generator
1501, 1501a, 1502, 1503, 2501, 2501a, 2502, 2502a, 7501, 9501, 9502, 9503, 10501 Preview image
1510, 1510a, 1510b, 1510c, 1511, 1512, 1512a Character information (display information)
1521, 1521a, 1521c Copy button (display information)
1522 Enlarge button (display information)
1523 Reduce button (display information)

What is claimed is:

1. An image processing apparatus, comprising:
a controller that performs control to display a preview image, and display information other than the preview image on a display screen, wherein
the display screen includes a preview image display area in which a preview image is displayed, and
when one or more preview images displayed in the preview image display area are enlarged or reduced, the controller performs control to enlarge or reduce the display information displayed on the display screen.

2. The image processing apparatus according to claim 1, wherein the display information includes at least one of an operation button and character information.

3. The image processing apparatus according to claim 1, wherein the controller enables the display of the display information in the preview image display area.

4. The image processing apparatus according to claim 2, wherein the controller enlarges or reduces and displays the display information when the display information is to be enlarged or reduced and displayed.

5. The image processing apparatus according to claim 1, wherein the controller sets a magnification at which the preview image is to be enlarged or reduced and displayed to be the same as a magnification at which the display information is to be enlarged or reduced and displayed.

6. The image processing apparatus according to claim 1, wherein the controller sets a magnification at which the preview image is to be enlarged or reduced and displayed to be different from a magnification at which the display information is to be enlarged or reduced and displayed.

7. The image processing apparatus according to claim 1, wherein the controller displays an operation button used for executing a function related to image editing as display information to be displayed, when the preview image is enlarged or reduced and displayed.

8. The image processing apparatus according to claim 1, wherein the controller sets an upper limit for a magnification at which the display information is to be enlarged or reduced and displayed regardless of a magnification at which the preview image is enlarged or reduced and displayed.

9. The image processing according to claim 8, wherein the controller sets an upper limit for a magnification at which the display information is to be enlarged or reduced and displayed so that the preview image and the display information are displayed without being superimposed.

10. The image processing apparatus according to claim 1, wherein the controller performs control to enlarge or reduce and display the preview image display area while enlarging or reducing and displaying the preview image.

11. The image processing apparatus according to claim 1, wherein the controller changes a magnification of enlarging or reducing the preview image in accordance with a number of preview images to be displayed.

12. The image processing apparatus according to claim 1, wherein the controller changes a magnification of enlarging or reducing the preview image display area in accordance with which the preview image being displayed longitudinally or laterally.
